(19) United States
(12) Patent Application Publication
(10) Pub. No.: US 2026/0169017 A1
(43) Pub. Date: Jun. 18, 2026

(54) A SAMPLE CARRIER TRANSPORT DEVICE

(71) Applicant: Roche Diagnostics Operations, Inc., Indianapolis, IN (US)

(72) Inventors: Renato Belz, Rotkreuz ZG (CH); Michael Graf, Cham (CH); Akihiro Yasui, Tokyo (JP); Saki Ueno, Tokyo (JP); Muneo Maeshima, Tokyo (JP)

(73) Assignee: Roche Diagnostics Operations, Inc., Indianapolis, IN (US)

(21) Appl. No.: 19/123,989

(22) PCT Filed: Oct. 23, 2023
(86) PCT No.: PCT/EP2023/079430

§ 371 Date: Apr. 24, 2025

(30) Foreign Application Priority Data
Oct. 24, 2022 (EP) 22203318.5

(51) Int. Cl. G01N 35/02; G01N 35/00

(52) U.S. Cl. CPC G01N 35/025; G01N 35/00029; G01N 2035/00138

(57) ABSTRACT

A sample carrier transport device for transporting sample carriers to a workstation. The sample carrier transport device comprises a surface having a plurality of sample carrier holder portions. Each sample carrier holder portion is configured for removably holding a sample carrier during transport of the sample carrier. The surface performs a movement for transporting the sample carrier to the workstation. The sample carrier transport device comprises a lifting mechanism for moving the surface to at least one transport position and to at least one transfer position. The transport position and the transfer position refer to different heights of the surface. The lifting mechanism is configured for holding the surface during transport of the sample carriers to the workstation in the transport position. The sample carrier transport device is configured for handing over the sample carrier to the workstation and for receiving the sample carrier from the workstation in the transfer position.

### TECHNICAL FIELD

The present invention refers to a sample carrier transport device for transporting sample carriers to a workstation for sample processing, an analysis system and a method for transporting sample carriers to a plurality of workstations of an analysis system. The method and device specifically may be used in the field of medical or chemical laboratories. Other fields of application of the present invention, however, are feasible.

### BACKGROUND ART

In the field of medical or chemical laboratories, a sample carrier transport device is used for distributing sample carriers, e.g. glass slides, from, to and between workstations, e.g. within one or more instruments of an analysis system. The traditional way of moving sample carriers in an instrument involves e.g. a vacuum gripper with many actuators. Because of the limited space in the instrument and the complex handling sequences, this type of internal slide transport is a limiting factor for the performance and reliability of the whole instrument.

U.S. Pat. No. 5,225,266 A describes a specimen slide in the form of a strip-shaped glass plate. To improve production and handling of the slide the glass plate is surrounded on all sides by a plastic frame.

US 2004/0191128 A 1 describes a microscope slide stainer which includes a platform that supports a plurality of microscope slides. The platform includes surface areas, heated by resistive heaters, under the microscope slides. A liquid dispenser is located above the platform and the dispenser and platform are adapted for relative movement with respect to each other. The dispenser dispenses liquid reagents onto a slide bearing a biological sample.

WO 2011/161353 A 1 describes fluid-dispensing equipment including at least one rotary tool holder fitted with an injection device provided with a plurality of fluid-injection members, a space for receiving a rotary collector, wherein said tool holder is rotatably mounted so as to enable each injection member to be brought into an injection preparation position, and an actuator capable of actuating at least one injection member when said injection member is in the injection preparation position thereof, wherein said actuator is also capable of moving upwards and downwards, thereby enabling an injection member to be actuated when said injection member is in the injection preparation position thereof. The rotational axes of the collector and tool holder and the upward and downward movement axis of the actuator are mutually parallel. The tool holder is also provided with a gripping member.

WO 2007/139892 A 2 describes a fluid dispensing apparatus includes a fluid reservoir and a dispensing assembly. The dispensing assembly includes a housing and a deformable member that define a metering chamber that is configured to receive a predetermined volume of fluid ftomthe fluid reservoir. The deformable member is deformed from a rest position to an eject position and the deformation causes the volume of the metering chamber to change which results in a change in fluid pressure within the metering chamber. An increase in the fluid pressure within metering chamber causes a predetermined volume of fluid within the metering chamber to be ejected and a decrease in the fluid pressure within the metering chamber causes fluid to be drawn into the metering chamber from the reservoir.

CN104655851A describes an antibody chip kit comprising antibody chips, a receptor standards mixture, a biotin labeled detection antibodies mixture and Cy3 fluorochrome labeled streptavidin. A standard tissue slide which is coated by reactive amino groups is chosen as a surface carrier of the antibody chips, and various antigen specific antibodies are adsorbed firmly on the surface of the slide by a non-contact spotting robot and sixteen microarrays are formed. The sixteen microarrays are then separated in non-interfering small areas by the use of a plastic frame with 2*8 holes and a latex closed frame which match each other and are demountable. Each capture antibody has four repeated spottings in each antibody microarray.

US 2014/161150 A 1 describes that an analyzer mixes the material to be analyzed and the flux in sample holders supported by a movable platform within the furnace. A tilt member is provided having multiple stations. Each station has an upstanding pin offset from the center point of the station in a different direction. The platform is indexed relative to the tilt member such that the sample holder aligns with each station, in sequence. As the sample holder aligns with each station, the platform is moved toward the tilt member such that the pin of the aligned station abuts and tilts the sample holder in a different direction. The repeated tilting of the sample holder in different directions mixes the material and flux. The contents of the sample holder may also be agitated by rapidly moving the platform back and forth with sudden stops.

### PROBLEM TO BE SOLVED

It is therefore desirable to provide a method and devices which at least partially address the above-mentioned technical challenges of known methods and devices of similar kind. Specifically, a method and devices shall be proposed which allow increasing the performance and reliability of an internal slide transport within an analysis system.

### SUMMARY

This problem is addressed by a sample carrier transport device for transporting sample carriers to a workstation for sample processing, an analysis system and a method for transporting sample carriers to a plurality of workstations of an analysis system with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a sample carrier transport device for transporting sample carriers to a workstation for sample processing is disclosed.

The term “sample” as used herein is a broad term and is to be given its ordinary and customary meaning to a person of ordinary skill in the art and is not to be limited to a special or customized meaning. The term specifically may refer, without limitation, to an aliquot of a substance such as a chemical or biological compound. Specifically, the sample may be or may comprise at least one biological specimen, such as one or more of: tissue sample; blood; blood serum; blood plasma; urine; saliva. Additionally or alternatively, the sample may be or may comprise a chemical substance or compound and/or a reagent. The biological specimens disclosed herein can include one or more biological samples that can be a tissue sample or samples (e.g., any collection of cells) removed from a subject. The tissue sample can be a collection of interconnected cells that perform a similar function within an organism. A biological sample can also be any solid or fluid sample obtained from, excreted by, or secreted by any living organism, including, without limitation, single-celled organisms, such as bacteria, yeast, protozoans, and amoebas, multicellular organisms (e.g., plants or animals, including samples from a healthy or apparently healthy human subject or a human patient affected by a condition or disease to be diagnosed or investigated, such as cancer). For example, the sample may comprise a section of tissue, an organ, a tumor section, a smear, a frozen section, a cytology prep, or cell lines. An incisional biopsy, a core biopsy, an excisional biopsy, a needle aspiration biopsy, a core needle biopsy, a stereotactic biopsy, an open biopsy, or a surgical biopsy can be used to obtain the sample.

The term “sample carrier” as used herein is a broad term and is to be given its ordinary and customary meaning to a person of ordinary skill in the art and is not to be limited to a special or customized meaning. The term specifically may refer, without limitation, to a support structure configured for one or more of supporting such as containing, storing or transporting the sample. The sample carrier may be a slide, e.g. a specimen slide. The sample carrier may be strip-shaped or disc-shaped. For example, the sample carrier is a glass slide such as a washable reusable glass disc or glass arm. The sample carrier may be disposable, e.g. made of glass or plastic, and/or reusable, e.g. made of glass. For example, the sample carrier may be washable.

The sample carrier may comprise at least one frame. The term “frame” as used herein is a broad term and is to be given its ordinary and customary meaning to a person of ordinary skill in the art and is not to be limited to a special or customized meaning. The term specifically may refer, without limitation, to a structure surrounding the sample carrier configured for one or more of supporting, protecting, stabilizing of the sample carrier. The frame may comprise an outer structure and a receptacle for receiving the sample carrier. The frame and the sample carrier may be shaped according to the key lock principle. The sample carrier may be inserted separably into the frame or may be inseparably connected with the frame. The frame may be a disposable or reusable frame. The frame may be a rigid frame, e.g. made of one or more of the following materials: Polystyrene (PS), polycarbonate (PC), Acrylnitril-Butadien-Styrol-Copolymer (ABS), aluminum, Polyetheretherketon (PEEK) , Polyphenylsulfone (PPSU), Polyoxymethylene (POM-C), Polypropylene (PP). For example, at least one of the following materials may be used for a disposable frame: Polystyrene (PS), polycarbonate (PC), Acrylnitril-Butadien-Styrol-Copolymer (ABS). For example, at least one of the following materials may be used for a reusable frame: aluminium, Polyetheretherketon (PEEK) , Polyphenylsulfone (PPSU), Polyoxymethylene (POM-C), Polypropylene (PP).

The sample carrier may comprises at least one identifier directly attached to the sample carrier and/or attached to the frame of the sample carrier. The sample carrier may be identifiable by an identification system or by human (clear text). The identification system may be a camera system or optical sensors and scanners identifying one or more of any optical signature on the sample carrier such as a barcode, a QR code, or another type of code. The identification system may be an element of the workstation or a separate element of an analysis system comprising the workstation. For example, the sample carrier may be a slide without an area of labeling. The sample carrier may be put, e.g. automatically, for example by a gripper, into the frame, which provides a unique ID to ensure the traceability.

The term “workstation” as used herein is a broad term and is to be given its ordinary and customary meaning to a person of ordinary skill in the art and is not to be limited to a special or customized meaning. The term specifically may refer, without limitation, to a location within an analysis system, e.g. within a laboratory instrument, configured for exhibiting a predefined function on the sample and/or sample carrier. The workstation may be configured for sample processing. The sample processing may comprise one or more of sample specific steps such as printing, smearing, staining, heating, drying, cooling, separating, mixing, washing, eluting, diluting, chemical reacting, aliquoting, imaging, scanning or the like. Each of the workstations may comprise at least one workstation selected from the group consisting of: a printing workstation, a staining workstation, a wasting station, an analysis station, an imaging station, a wasting station, an imaging station, a labeling station, an intermediate store station, a reprocessing treatment station, a handing over station for further manual examination. The workstation may be an element of an analysis system, e.g. of a laboratory instrument of the analysis system. The analysis system, e.g. the laboratory instrument, may comprise a plurality of workstations. The sample carrier transport device may be configured for transporting the sample carriers from one workstation to another workstation. The sample carrier transport device may be configured for transporting the sample carriers between workstations.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components forming a whole. Specifically, the components may interact with each other in order to fulfill at least one common function. The system may comprise at least two components, wherein the at least two components may be handled independently or may be coupled or connectable.

The term “analysis system” as used herein is a broad term and is to be given its ordinary and customary meaning to a person of ordinary skill in the art and is not to be limited to a special or customized meaning. The term specifically may refer, without limitation, to a system comprising at least one laboratory instrument. The analysis system may be at least one analysis system selected from the group consisting of: a hematology blood analysis system, tissue analysis system, a urine sediment analysis system.

The term “laboratory instrument” as used herein is a broad term and is to be given its ordinary and customary meaning to a person of ordinary skill in the art and is not to be limited to a special or customized meaning. The term specifically may refer, without limitation, to any device configured for performing at least one sample processing step, e.g. a plurality of processing steps such as a pre-defined workflow. For example, the laboratory instrument may be a clinical diagnostic analyzer. The laboratory instrument may be one or more of a pre-analytical, an analytical, or a post-analytical instrument, or a combined laboratory instrument. A pre-analytical instrument can usually be used for the preliminary processing of samples. The pre-analytical instrument may comprise workstations e.g. for heating, printing, staining, drying, cooling, pipetting, separating, mixing, washing, eluting, diluting, chemical reacting, aliquoting, conservation of samples and/or reagents, detecting, e.g. at least one sample quality check. An analytical instrument, also denoted as analyzer, may be designed, for example, to use a sample or part of the sample and a reagent in order to produce a measurable signal, on the basis of which it is possible to determine whether the analyte is present, and if desired in what concentration and quality. The analytical instrument may be operable to determine via various chemical, biological, physical, optical or other technical procedures a parameter value of the sample or a component thereof. The analytical instrument may be operable to measure said parameter of the sample or of at least one analyte and return the obtained measurement value, e.g. the analysis result. For example, possible analysis results returned by the analytical instrument may be concentrations of the analyte in the sample, and the like. The analytical instrument may comprise at least one workstation, e.g. at least one analysis station e.g. for imaging, scanning, determination of a result and the like. A post-analytical instrument can usually be used for the post-processing of samples like the archiving and/or wasting of samples. The post-analytical instrument may comprise a handing over station for further manual examination.

The workstation may comprise at least one head. The term “head” as used herein is a broad term and is to be given its ordinary and customary meaning to a person of ordinary skill in the art and is not to be limited to a special or customized meaning. The term specifically may refer, without limitation, to an element or a plurality of elements configured for performing the one or more processing steps on sample which are to take place at the respective workstation. The head may be moveable, e.g. by using at least one movable arm.

The workstation may comprise a sealing configured for preventing leakage from the sample carrier during processing e.g. staining, washing. For example, the sealing may comprise at least one axial sealing lip. For example, the head of the workstation may be pressed against the sample carrier using an axial sealing lip. This may ensure that preventing leakage during sample processing. The axial sealing lip may prevent contamination from the instrument to the sample and/or cross-Contamination (from sample to sample).

The sample carrier transport device comprises a surface having a plurality of sample carrier holder portions. Each of the sample carrier holder portions is configured for removably holding at least one sample carrier during transport of the sample carrier to the workstation. The surface is configured for performing a movement for transporting the sample carrier to the workstation. The sample carrier transport device comprises at least one lifting mechanism configured for moving the surface to at least one transport position and to at least one transfer position. The transport position and the transfer position refer to different heights of the surface. The lifting mechanism is configured for holding the surface during transport of the sample carriers to the workstation in the transport position. The sample carrier transport device is configured for handing over the sample carrier to the workstation and for receiving the sample carrier from the workstation in the transfer position.

The term “sample carrier transport device” as used herein is a broad term and is to be given its ordinary and customary meaning to a person of ordinary skill in the art and is not to be limited to a special or customized meaning. The term specifically may refer, without limitation, to a device configured for transporting sample carriers from an initial position to a target workstation and/or from one workstation to another workstation. For example, the analysis system may comprise a plurality of workstations. The analysis system may be configured for performing a pre-defined workflow of sample processing steps at different workstations. The sample carrier transport device may be configured for transporting the sample carrier successively to the respective workstations for performing the workflow.

The sample carrier transport device may be configured for transporting sample carriers to a plurality of workstations. The term “transport” as used herein is a broad term and is to be given its ordinary and customary meaning to a person of ordinary skill in the art and is not to be limited to a special or customized meaning. The term specifically may refer, without limitation, to a relative movement of the sample carrier transport device, e.g. of a surface of the sample carrier transport device with respect to the workstations. For example, the transport may comprise a rotational movement around an axis of rotation. The movement of the surface of the sample carrier transport device may, however, be not limited to a rotatory motion. In addition or alternatively, a linear motion in a x- and/or y-axis can be implemented.

For example, the sample carrier transport device is a rotor. The surface may be a circular surface. The rotor may be configured for performing a rotational movement of 360° or less than 360° around the axis of rotation of the rotor. However, even movement of more than 360° may be possible. Thus, the sample carrier transport device may comprise a sample carrier rotor with sample carrier holder portions used for transporting sample carriers from workstation to workstation. The sample carrier transport device may comprise at least one drive mechanism configured for driving the rotational movement of the surface. Such drive mechanisms are known to the skilled person.

Other embodiments of the sample carrier transport device are feasible. For example, the sample carrier transport device may be or may comprise at least one arm, e.g. made of aluminum.

For example, the sample carrier transport device is a linear stage. The surface may be an elongated surface along at least one direction, e.g. the x direction or y direction. Workstations may be arranged at different x positions or y positions respectively e.g. equally spaced. The linear stage may be configured for performing a linear step movement corresponding to the distance between two workstations or to a multiple of the distance between two workstations. Thus, the sample carrier transport device may comprise a linear sample carrier with sample carrier holder portions linearly spaced between them at a distance between two consecutive sample carrier holder portions corresponding to the distance between two consecutive workstations, used for transporting sample carriers from workstation to workstation. The sample carrier transport device may comprise at least one drive mechanism configured for driving the linear movement of the surface. Such drive mechanisms are known to the skilled person.

The sample carrier transport device may additionally comprise a curved component configured for changing a direction, e.g. of linear movement into a curved movement and may be configured for performing a linear movement in a loop, with workstations arranged at different positions along the loop. Additionally or alternatively, the direction of linear movement can be reversed in the opposite direction. Also, the linear stage may be configured to move both in the x and y directions and several workstations may be arranged both along the x and y directions and the distance between workstations can be any.

The term “sample carrier holder portion” as used herein is a broad term and is to be given its ordinary and customary meaning to a person of ordinary skill in the art and is not to be limited to a special or customized meaning. The term specifically may refer, without limitation, to an element of the surface configured for removably holding at least one sample carrier during transport of the sample carrier to the workstation. The sample carrier holder portions may be configured for movably positioning the sample carriers on the sample carrier transport device. For example, the sample carrier holder portion may be configured for receiving and holding the sample carrier and/or the frame of the sample carrier. The sample carrier holder portion may be a receptacle configured for receiving and holding the sample carrier and/or the frame of the sample carrier. The sample carrier holder portion may be designed as a recess of the surface and/or at least one attachment, e.g. for mechanical connection between the sample carrier holder portion and the sample carrier. The sample carrier holder portions, e.g. the attachment, may be designed such that the attachment provides a distance between the sample carrier and the sample carrier transport device. The sample carrier holder portions, e.g. the attachment, may be designed such that the sample carriers have no direct contact with the sample carrier transport device. For example, the attachment may be a frame. The sample carrier holder portion may be configured for circumferentially surrounding the sample carrier. The sample carrier holder portion may be configured for holding the sample carrier by using one or more of suction, exhausting a vacuum, form-fit and/or force-fit connection.

The sample carrier transport system may comprise at least one gripper configured for loading the sample carrier onto the surface. Once a sample carrier is loaded onto the rotor by the gripper, the rotor may transport the sample carrier to a first workstation by rotating.

The term “gripper” as used herein is a broad term and is to be given its ordinary and customary meaning to a person of ordinary skill in the art and is not to be limited to a special or customized meaning. The term specifically may refer, without limitation, to a device designed for gripping a sample carrier. The term “gripping” as used herein is a broad term and is to be given its ordinary and customary meaning to a person of ordinary skill in the art and is not to be limited to a special or customized meaning. The term specifically may refer, without limitation, to temporarily connecting the sample carrier to the gripper such that the sample carrier can be lifted or otherwise moved by with the gripper. The gripping may comprise one or more of using suction, exhausting a vacuum, form-fit gripping, force-fit gripping.

The plurality of sample carrier holder portions may be arranged on the surface of the sample carrier transport device. The presence of a plurality of sample carrier holder portions may having a plurality of sample carriers on the sample carrier transport device. Thus, parallel processing of a plurality of sample carriers at different workstations may be possible. The plurality of workstations allow for performing parallel actions at difference workstations independently of each other. The parallel actions at the different workstations may comprise e.g. printing, staining, imaging etc. For example, the sample carrier holder portions may be evenly distributed on the surface. For example, the sample carrier holder portions may be arranged on the surface with respect to distances between the respective workstations.

The present invention proposes a special mechanism of interaction of sample carrier and the workstations. Specifically, the present invention proposes a lifting mechanism.

The term “lifting mechanism” as used herein is a broad term and is to be given its ordinary and customary meaning to a person of ordinary skill in the art and is not to be limited to a special or customized meaning. The term specifically may refer, without limitation, to an arbitrary mechanism configured for setting the height of the surface. The lifting mechanism may be configured for performing at least one lifting movement. The lifting mechanism may be configured for setting the height of the surface to at least two different positions. The lifting mechanism may be configured for setting the height of the surface to the transfer position and to the transport position. The lifting mechanism is configured for moving, e.g. lifting, the surface from a first position, e.g. one of the transfer position and the transport position, to a second position, e.g. the other one of the transfer position and the transport position. The lifting mechanism is configured for moving, e.g. lowering, the surface from the second position to the first position. For example, the lifting mechanism may comprise at least one lifting stage. The lifting mechanism may comprise at least one drive mechanism configured for driving the lifting movement of the surface. Such drive mechanisms are known to the skilled person.

The term “transport position” as used herein is a broad term and is to be given its ordinary and customary meaning to a person of ordinary skill in the art and is not to be limited to a special or customized meaning. The term specifically may refer, without limitation, to a height of the surface during transport of the sample carriers to the workstation. The term “transfer position” as used herein is a broad term and is to be given its ordinary and customary meaning to a person of ordinary skill in the art and is not to be limited to a special or customized meaning. The term specifically may refer, without limitation, to a height of the surface during handing over the sample carrier to the workstation and for receiving the sample carrier from the workstation. The transport position and the transfer position refer to different heights of the surface.

The term “handing over” to the workstation as used herein is a broad term and is to be given its ordinary and customary meaning to a person of ordinary skill in the art and is not to be limited to a special or customized meaning. The term specifically may refer, without limitation, to the process of releasing the sample carrier from the surface of the sample carrier transport device and transferring the sample carrier to the workstation for processing. The handing over of the sample carrier in the transfer position may comprise providing an access to the sample carrier from the workstation. Each of the sample carrier holder portions may comprise at least one opening. The opening may be configured for providing access to sample carrier from the workstation by one or more of: engaging, suction, exhausting a vacuum, form-fit gripping, force-fit gripping.

The workstation may comprise a stage configured for moving the handed over sample carrier along an x- and/or a y-axis to a position of processing. The term “stage” as used herein is a broad term and is to be given its ordinary and customary meaning to a person of ordinary skill in the art and is not to be limited to a special or customized meaning. The term specifically may refer, without limitation, to a movable element configured for receiving the sample carrier and for moving the sample carrier in the position of processing within the workstation. The stage of the certain workstation may be configured for moving, e.g. along an x-axis and/or a y-axis, the sample carrier to an intended position of processing. The movement of the surface of the sample carrier transport device and the stage of the workstation may be described in a Cartesian coordinate system. The movement of the surface may be along a z-axis, wherein the x-axis and the y-axis along are perpendicular thereto. In addition or alternatively to the movement of the stage along the x-axis and/or the y-axis, the stage may be configured for moving the sample carrier the z-axis. As outlined above, the workstation may comprise a head. The head may be configured for moving along the z-axis to the position of processing.

In the analysis system, the workstations and the sample carrier transport device are arranged relative to each other such that the sample carrier can be handed over of from the sample carrier transport device to the workstation and can be received from the workstation by the sample carrier transport device in the transfer position.

For example, the transport position is above the transfer position. The lifting mechanism may be configured for lifting the surface from the transfer position to the transport position for receiving the sample carrier from the workstation and transport of the sample carrier, and for lowering the surface from the transport position to the transfer position for handing over the sample carrier to the workstation.

For example, the transport position is below the transfer position. The lifting mechanism may be configured for lowering the surface from the transfer position to the transport position for receiving the sample carrier from the workstation and transport of the sample carrier, and for lifting the surface from the transport position to the transfer position for handing over the sample carrier to the workstation.

The handing over of the sample carrier may comprise placing the sample carrier on the stage of the workstation by moving the surface to the transfer position. The workstation may comprise at least one gripper configured for holding the sample carrier when the sample carrier is handed over to the workstation. For example, the gripper may be configured for holding the sample carrier by one or more of suction, exhausting a vacuum, form-fit gripping, force-fit gripping. The gripper may be configured for lifting the sample carrier from the surface of the sample carrier transport device to the stage of the workstation.

Each of the sample carrier holder portions may comprise at least one sliding mechanism. The sliding mechanism may be configured for providing of the sample carrier in the transfer position by sliding the sample carrier out of the sample carrier holder portion into the workstation. The term “sliding” as used herein is a broad term and is to be given its ordinary and customary meaning to a person of ordinary skill in the art and is not to be limited to a special or customized meaning. The term specifically may refer, without limitation, to frictional motion between two surfaces, e.g. a surface of the sample carrier and a surface of the sample carrier holder portion and/or the surface of the sample carrier and a surface of the stage of the workstation, in contact.

Each of the sample carrier holder portions may comprises at least one flipping mechanism. The flipping mechanism may be configured for providing of the sample carrier in the transfer position by flipping the sample carrier out of the sample carrier holder portion into the workstation. The term “flipping” as used herein is a broad term and is to be given its ordinary and customary meaning to a person of ordinary skill in the art and is not to be limited to a special or customized meaning. The term specifically may refer, without limitation, to a movement of ejection and/or turn and/or catapulting out the sample carrier from the sample carrier holder portion.

The handing over may be performed as follows. The lifting mechanism may lower the surface and the sample carrier may be placed onto the stage of one of the workstations. Once the sample carrier is placed onto the stage of the workstation, a vacuum exhauster may hold tight the sample carrier immediately. No x-y banking of the sample carrier may be needed. The stage of the workstation may move (along the x- and/or y-axis) the sample carrier to the intended position of processing. Afterwards, the head of the workstation may move (e.g. along the z-axis) to the intended position of processing. The process, e.g. printing, staining, imaging etc., can start.

The receiving of the sample carrier by the sample carrier holder portion from the workstation can be performed comprising the revers steps as the handing over to the workstation. For example, after the processing at the respective workstation is completed, the stage of the workstation may move the sample carrier back to the initial handing over position. The gripper may lift the sample carrier from the stage back to the sample carrier holder portion. The gripper, e.g. the vacuum exhauster may end a vacuum. Afterwards, the surface of the sample carrier transport device may transport the sample carrier to a next workstation. At the next workstation, the sample carrier may be processed again. At the end of the sample processing, i.e. after passing all workstations that are to be approached by the sample carrier according to a pre-defined workflow, the sample carrier may be, e.g. automatically, wasted or may be prepared for further manual examination.

As outlined above, the traditional way of moving glass slides in an instrument involves e.g. a vacuum gripper with many actuators. Because of the limited space in the instrument and the complex handling sequences, this type of internal slide transport is a limiting factor for the performance and reliability of the whole instrument. The proposed handling of the sample carrier has the advantage that the sample carriers can be transported in a carefully reliable way by a sample carrier transport device, e.g. a rotor, so that almost no breakage of glass is caused. The proposed concept may enabling a space-saving sample transport design in the instrument.

US 2014/161150 A 1 describes an internal carousel moving within a pre-heated furnace and for generating a homogeneous mixture of the samples within the sample holders. Such an internal carousel is not suitable for transporting a sample carrier to any workstation but relates to an internal carousel within a working station. Moreover, the lifting is not configured for moving the surface to at least one transport position and to at least one transfer position.

In a further aspect of the invention, an analysis system is disclosed. The analysis system comprises a plurality of workstations for sample processing and at least one sample carrier transport device according to the present invention. The workstations and the sample carrier transport device are arranged relative to each other such that the sample carrier can be handed over of from the sample carrier transport device to the workstation and can be received from the workstation by the sample carrier transport device in the transfer position.

With respect to definitions and embodiments of the analysis system reference is made to the definitions and embodiments of the sample carrier transport device, such as according to any one of the embodiments disclosed above and/or according to any one of the embodiments disclosed in further detail below.

The analysis system may comprise at least one control unit for controlling the sample carrier transport device. The control unit may be configured for controlling transfer of the sample carrier between the sample carrier transport device and the working stations. For example, the control unit may be configured for controlling one or more of movement of the surface of the sample carrier transport device, the lifting mechanism, the transfer of the sample carrier to and from the workstation, e.g. the gripper, the processes at the workstation, e.g. movement of the stage and/or head, processing steps, and the like. The term “control unit” as used herein is a broad term and is to be given its ordinary and customary meaning to a person of ordinary skill in the art and is not to be limited to a special or customized meaning. The term specifically may refer, without limitation, to an arbitrary device adapted to perform the controlling and processing, preferably by using at least one data processing device and, more preferably, by using at least one processor and/or at least one application-specific integrated circuit. Thus, as an example, the control unit may comprise one or more programmable devices such as one or more computers, application-specific integrated circuits (ASICs), Field Programmable Gate Arrays (FPGAs), or other devices which are configured for performing the controlling and/or processing. Thus, as an example, the control unit may comprise at least one data processing device having a software code stored thereon comprising a number of computer commands. The control unit may provide one or more hardware elements for performing one or more of the named operations and/or may provide one or more processors with software running thereon for performing one or more of the named operation.

In a further aspect of the invention, a method for transporting sample carriers to a plurality of workstations of an analysis system according to the present invention is disclosed.

The method comprises the method steps as given in the respective independent claim and as listed as follows. The method steps may be performed in the given order. However, other orders of the method steps are feasible. Further, one or more of the method steps may be performed in parallel and/or on a timely overlapping fashion. Further, one or more of the method steps may be performed repeatedly. Further, additional method steps may be present which are not listed.

The method comprises the following steps:
a) providing the sample carriers to the sample carrier holder portions of the surface of the sample carrier transport device;
b) transporting the sample carriers to the respective workstation by
performing a movement of the surface, wherein each of the sample carrier holder portions removably holds a sample carrier during the transport, wherein the surface is held in a transport position during the transport by the lifting mechanism;
c) handing over the sample carrier from the sample carrier transport device to the respective workstation by using the lifting mechanism, wherein the surface is moved from the transport position to the transfer position such that the workstation can access the sample carrier.

With respect to definitions and embodiments of the method reference is made to the definitions and embodiments of the sample carrier transport device and the analysis system, such as according to any one of the embodiments disclosed above and/or according to any one of the embodiments disclosed in further detail below.

The method may further comprise processing the sample at the workstation.

The method may further comprise receiving the sample carrier by the sample carrier transport device from the workstation in the transfer position and moving the surface from the transfer position to the transport position for further transport of the sample carrier.

The method may be performed automatically. The term “automatically” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user.

The method may be computer-implemented. The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processor, in particular the processing unit. The term “computer”, thus, may generally refer to a device or to a combination or network of devices having at least one data processing means such as at least one processor. The computer, additionally, may comprise one or more further components, such as at least one of a data storage device, an electronic interface or a human-machine interface.

Further disclosed and proposed herein is a computer program including computer-executable instructions for performing the method according to the present invention in one or more of the embodiments enclosed herein when the instructions are executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to c) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a non-transient computer-readable medium including instructions that, when executed by one or more processors, cause the one or more processors to perform the method according to the present invention.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:
Embodiment 1. A sample carrier transport device for transporting sample carriers to a workstation for sample processing,
wherein the sample carrier transport device comprises a surface having a plurality of sample carrier holder portions, wherein each of the sample carrier holder portions is configured for removably holding at least one sample carrier during transport of the sample carrier to the workstation, wherein the surface is configured for performing a movement for transporting the sample carrier to the workstation,
wherein the sample carrier transport device comprises at least one lifting mechanism configured for moving the surface to at least one transport position and to at least one transfer position, wherein the transport position and the transfer position refer to different heights of the surface, wherein the lifting mechanism is configured for holding the surface during transport of the sample carriers to the workstation in the transport position, wherein the sample carrier transport device is configured for handing over the sample carrier to the workstation and for receiving the sample carrier from the workstation in the transfer position.
Embodiment 2. The sample carrier transport device according to the preceding embodiment, wherein the handing over of the sample carrier in the transfer position comprises providing an access to the sample carrier from the workstation.
Embodiment 3. The sample carrier transport device according to any one of the preceding embodiments, the handing over of the sample carrier comprises placing the sample carrier on a stage of the workstation by moving the surface to the transfer position.
Embodiment 4. The sample carrier transport device according to any one of the preceding embodiments, wherein each of the sample carrier holder portions comprises at least one opening, wherein the opening is configured for providing access to sample carrier from the workstation by one or more of: engaging, suction, exhausting a vacuum, form-fit gripping, force-fit gripping.
Embodiment 5. The sample carrier transport device according to any one of the preceding embodiments, wherein each of the sample carrier holder portions comprises at least one sliding mechanism, wherein the sliding mechanism is configured for providing of the sample carrier in the transfer position by sliding the sample carrier out of the sample carrier holder portion into the workstation.
Embodiment 6. The sample carrier transport device according to any one of the preceding embodiments, wherein each of the sample carrier holder portions comprises at least one flipping mechanism, wherein the flipping mechanism is configured for providing of the sample carrier in the transfer position by flipping the sample carrier out of the sample carrier holder portion into the workstation.
Embodiment 7. The sample carrier transport device according to any one of the preceding embodiments, wherein the transport position is above the transfer position, wherein the lifting mechanism is configured for lifting the surface from the transfer position to the transport position for receiving the sample carrier from the workstation and transport of the sample carrier, and for lowering the surface from the transport position to the transfer position for handing over the sample carrier to the workstation, or
wherein the transport position is below the transfer position and wherein the lifting mechanism is configured for lowering the surface from the transfer position to the transport position for receiving the sample carrier from the workstation and transport of the sample carrier, and for lifting the surface from the transport position to the transfer position for handing over the sample carrier to the workstation.
Embodiment 8. The sample carrier transport device according to any one of the preceding embodiments, wherein the sample carrier holder portion is configured for circumferentially surrounding the sample carrier.
Embodiment 9. The sample carrier transport device according to any one of the preceding embodiments, wherein the sample carrier holder portion is configured for holding the sample carrier by using suction, exhausting a vacuum, form-fit and/or force-fit connection.
Embodiment 10. The sample carrier transport device according to any one of the preceding embodiments, wherein the sample carrier transport device is configured for transporting sample carriers to a plurality of workstations, wherein the sample carrier holder portions are arranged on the surface with respect to distances between the respective workstations.
Embodiment 11. The sample carrier transport device according to any one of the preceding embodiments, wherein the sample carrier transport device is a rotor, wherein the surface is a circular surface.
Embodiment 12. The sample carrier transport device according to any one of the two preceding embodiments, wherein the rotor is configured for performing a rotational movement of 360° or less than 360° around an axis of rotation of the rotor.
Embodiment 13. The sample carrier transport device according to any one of the two preceding embodiments, wherein the sample carrier transport device is or comprises at least one arm.
Embodiment 14. The sample carrier transport device according to any one of the preceding embodiments, wherein the sample carrier transport device is configured for performing a linear motion in an x- and/or in an y-axis.
Embodiment 15. The sample carrier transport device according to any one of the preceding embodiments, wherein the sample carrier is a glass slide such as a washable reusable glass disc or glass arm.
Embodiment 16. The sample carrier transport device according to any one of the preceding embodiments, wherein the sample carrier is disposable and/or reusable.
Embodiment 17. The sample carrier transport device according to any one of the preceding embodiments, wherein the sample carrier comprises at least one identifier directly attached to the sample carrier and/or attached to the sample carrier by using a disposable or reusable frame.
Embodiment 18. An analysis system comprising a plurality of workstations for sample processing and at least one sample carrier transport device according to any one of the preceding embodiments, wherein the workstations and the sample carrier transport device are arranged relative to each other such that the sample carrier can be handed over of from the sample carrier transport device to the workstation and can be received from the workstation by the sample carrier transport device in the transfer position.
Embodiment 19. The analysis system according to the preceding embodiment, wherein the workstation comprises a stage configured for moving the handed over sample carrier along an x- and/or a y-axis to a position of processing.
Embodiment 20. The analysis system according to the preceding embodiment, wherein the workstation comprises a head configured for moving along a z-axis to the position of processing.
Embodiment 21. The analysis system according to any one of the preceding embodiments referring to an analysis system, wherein each of the workstations comprises at least one workstation selected from the group consisting of: a printing workstation, a staining workstation, an analysis station, an imaging station, a wasting station, a labeling station, an intermediate store station, a reprocessing treatment station, a handing over station for further manual examination.
Embodiment 22. The analysis system according to any one of the preceding embodiments referring to an analysis system, wherein the workstation comprises at least one sample carrier gripper configured for holding the sample carrier when the sample carrier is handed over to the workstation.
Embodiment 23. The analysis system according to any one of the preceding embodiments referring to an analysis system, wherein the workstation comprises a sealing configured for preventing leakage from the sample carrier during processing.
Embodiment 24. The analysis system according to any one of the preceding embodiments relating to an analysis system, wherein the sample carrier transport system comprises at least one gripper configured for loading the sample carrier onto the surface.
Embodiment 25. The analysis system according to any one of the preceding embodiments referring to an analysis system, wherein the analysis system comprises at least one control unit for controlling the sample carrier transport device, wherein the control unit is configured for controlling transfer of the sample carrier between the sample carrier transport device and the working stations.
Embodiment 26. The analysis system according to any one of the preceding embodiments relating to an analysis system, wherein the analysis system is at least one analysis system selected from the group consisting of: a hematology blood analysis system, tissue analysis system, a urine sediment analysis system.
Embodiment 27. A method for transporting sample carriers to a plurality of workstations of an analysis system according to any one of the preceding embodiments relating to an analysis system, wherein the method comprises the following steps:
a) providing the sample carriers to the sample carrier holder portions of the surface of the sample carrier transport device;
b) transporting the sample carriers to the respective workstation by
performing a movement of the surface, wherein each of the sample carrier holder portions removably holds a sample carrier during the transport, wherein the surface is held in a transport position during the transport by the lifting mechanism;
c) handing over the sample carrier from the sample carrier transport device to the respective workstation by using the lifting mechanism, wherein the surface is moved from the transport position to the transfer position such that the workstation can access the sample carrier.
Embodiment 28. The method according to the preceding embodiment, wherein the method further comprises processing the sample at the workstation.
Embodiment 29. The method according to any one of the two preceding embodiments, wherein the method further comprises receiving the sample carrier by the sample carrier transport device from the workstation in the transfer position and moving the surface from the transfer position to the transport position for further transport of the sample carrier.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A to 1C show an embodiment of a method for transporting sample carriers to a plurality of workstations of an analysis system and an analysis system according to the present invention.

### DETAILED DESCRIPTION OF THE EMBODIMENTS

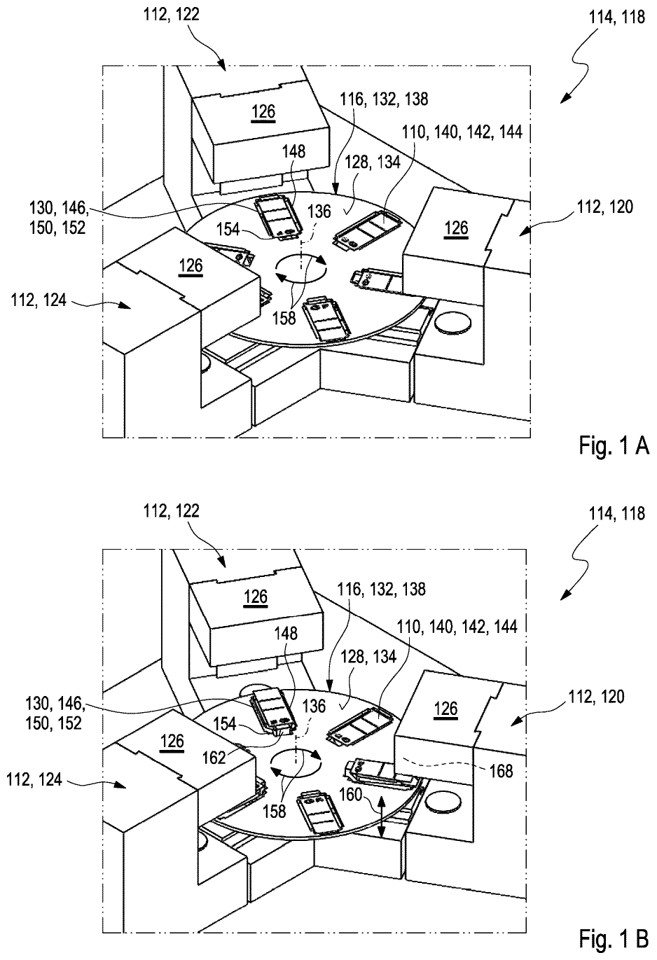

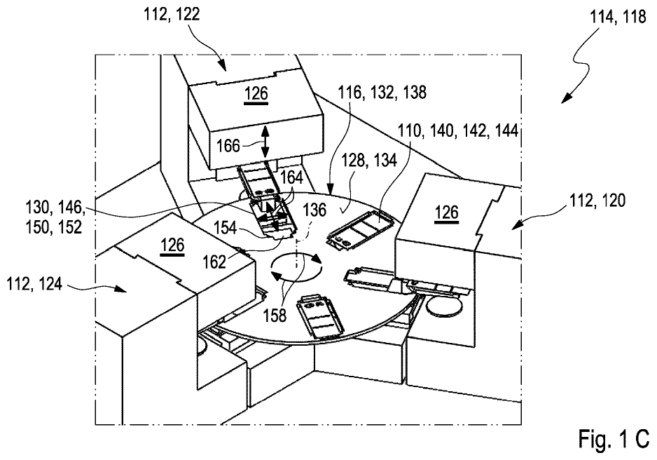

FIGS. 1A to 1C show an embodiment of a method for transporting sample carriers 110 to a plurality of workstations 112 of an analysis system 114 and an analysis system 114 according to the present invention.

As illustrated in FIG. 1A, the analysis system 114 comprising a plurality of the workstations 112 for sample processing and further comprising at least one sample carrier transport device 116 is illustrated. The analysis system 114 may exemplarily be an hematology blood analysis system 118.

The workstations 112 may be configured for sample processing. The sample processing may comprise one or more of sample specific steps such as printing, smearing, staining, heating, drying, cooling, separating, mixing, washing, eluting, diluting, chemical reacting, aliquoting, imaging, scanning or the like. The analysis system as illustrated in FIG. 1A may comprise a imaging workstation 120, a staining workstation 122 and a printing workstation 124.

The workstations 112 may respectively comprise at least one head 126. The head 126 may be configured for performing the one or more processing steps on a sample which are to take place at the respective workstation 122. The head 126 may be moveable.

The workstations 112 and the sample carrier transport device 116 are arranged relative to each other such that the sample carrier 110 can be handed over of from the sample carrier transport device 116 to one of the workstations 112 and can be received from one of the workstations 112 by the sample carrier transport device 116 in a transfer position.

The sample carrier transport device 116 comprises a surface 128 having a plurality of sample carrier holder portions 130. For example, the sample carrier transport device 116 is a rotor 132. The surface 128 may be a circular surface 134. The rotor 132 may be configured for performing a rotational movement of 360° or less than 360° around an axis of rotation 136 of the rotor 132. However, even movement of more than 360° may be possible. Thus, the sample carrier transport device 116 may comprise a sample carrier rotor 138 with sample carrier holder portions 130 used for transporting sample carriers 110 from workstation 112 to workstation 112. The sample carrier transport device 116 may comprise at least one drive mechanism configured for driving the rotational movement of the surface 128.

Each of the sample carrier holder portions 130 is configured for removably holding at least one sample carrier 110 during transport of the sample carrier 110 to the workstation 112. The sample carrier 110 may be a slide 140, e.g. a specimen slide 142. The sample carrier 110 may be strip-shaped or disc-shaped. For example, the sample carrier 110 is a glass slide 144.

The sample carrier holder portion 130 may be a receptacle 146 configured for receiving and holding the sample carrier 110 and/or a frame 148 of the sample carrier 110. The sample carrier holder portion 130 may be designed as a recess 150 of the surface 128. The sample carrier holder portion 130 may be configured for circumferentially surrounding the sample carrier 110. The sample carrier holder portion 130 may be configured for holding the sample carrier 110 by using one or more of suction, exhausting a vacuum, form-fit and/or force-fit connection.

The sample carrier holder portion 130 may serve as holder 152 of the sample carriers 110 during transport. The sample carriers 110 may be movably but precisely positioned in the sample carrier holder portions 130 on the surface 128 and may be held circumferentially in the frame 148. The frame 148 and the sample carrier 110 may be shaped according to the key lock principle. The sample carrier 110 may be inserted separately into the frame 148 or may be inseparably connected with the frame 148.

Simple placing and removal of the sample carrier 110 on the sample carrier transport device 116 may be ensured. At each of the sample carrier holder portions 130 on the sample carrier transport device 116 there may be openings 154, which allow access to the sample carrier 110 from the workstations 112. The openings 154 may be configured for providing access to sample carrier 110 from the workstation 112 by one or more of: engaging, suction, exhausting a vacuum, form-fit gripping, force-fit gripping.

As illustrated in FIG. 1A, the sample carriers 110 are provided to the sample carrier holder portions 130 of the surface 128 of the sample carrier transport device 116. Exemplarily, the analysis system 110 may comprise at least one gripper (not shown in FIGS. 1A to 1C) configured for loading the sample carrier 110 onto the surface 128.

The sample carrier transport device 116 comprises at least one lifting mechanism configured for moving the surface to at least one transport position and to at least one transfer position. The transport position and the transfer position refer to different heights of the surface 128. The lifting mechanism is configured for holding the surface 128 during transport of the sample carriers 110 to the workstation 112 in the transport position.

As further illustrated in FIG. 1A, the sample carriers 110 are transported to the respective workstation 112 by performing a movement of the surface 128, wherein each of the sample carrier holder portions 130 removably holds a sample carrier 110 during the transport and wherein the surface 128 is held in a transport position during transport by the lifting mechanism.

The surface 128 is configured for performing a movement for transporting the sample carrier 110 to the workstation 112. Once a sample carrier 110 is loaded onto the rotor 132 by the gripper, the rotor 132 may transport the sample carrier 110 to a first workstation by rotating. The rotation is illustrated in FIG. 1A with arrows 158.

The sample carrier transport device 116 is configured for handing over the sample carrier 110 to the workstation 112 and for receiving the sample carrier 110 from the workstation 112 in the transfer position.

As illustrated in FIG. 1B, the sample carrier 110 is handed over from the sample carrier transport device 116 to the respective workstation 112 by using the lifting mechanism, wherein the surface 128 is moved from the transport position to the transfer position such that the workstation 112 can access the sample carrier 110.

The rotor 132 may lower, such as indicated in FIG. 1B with arrow 160 and the sample carrier 110 may be placed onto a stage 162 of a workstation 112. The stage 162 may be configured for moving the handed over sample carrier 110 along an x- and/or y-axis to a position of processing. The stage 162 of the certain workstation 112 may be configured for moving, e.g. along an x-axis and/or y-axis, the sample carrier 110 to an intended position of processing. The head 126 may be configured for moving along the z-axis to the position of processing.

Once the sample carrier 110 is placed onto the stage 162 of the workstation 112 a vacuum exhauster 168 may hold tight the sample carrier 110 immediately. No x-y banking of the sample carrier 110 may be needed.

As illustrated in FIG. 1C, the stage 162 of the certain workstation 112 may move, specifically in the x-y-axis, such as indicated with arrows 164, the sample carrier 110 to an intended position of processing. Afterwards, the head 126 of the certain workstation 112 may move, specifically along the z-axis, to the intended position of processing such as indicated with arrow 166. Thereafter, the process, e.g. printing, staining, imaging, may be started.

The sample carrier holder portion 130 on the rotor 132, which may be located between the staining workstation 122 and the imaging workstation 120 may be configured to dry a printed sample carrier by free air convection.

At the staining workstation 122, the head 126 of the staining workstation 122 may be pressed against the sample carrier 110 using at least one axial sealing lip, specifically to ensure no leakage occur during staining process.

After the process is completed, the stage 162 of the workstation 112 may move the sample carrier 110 back to an initial rotor handing over position.

The vacuum exhauster 168 may end vacuum. The rotor 132 may hand over the sample carrier 110 by lifting.

Afterwards, the rotor 132 may transport the sample carrier 110 to the next workstation 112. The sample carrier 110 may be processed again. Once the result is determined, the sample carrier 110 may be automatically wasted or may be prepared for further manual examination.

Generally, the sample carrier 110 may be transported in a carefully reliable way by the rotor 132, so that almost no glass dust is caused. The sample carrier rotor concept may enable a space-saving sample transport design in the analysis system 114.

### List of Reference Numbers

110 sample carrier
112 workstation
114 analysis system
116 sample carrier transport device
118 hematology blood analysis system
120 imaging workstation
122 staining workstation
124 printing workstation
126 head
128 surface
130 sample carrier holder portion
132 rotor
134 circular surface
136 axis of rotation
138 sample carrier rotor
140 slide
142 specimen slide
144 glass slide
146 receptacle
148 frame
150 recess
152 holder
154 opening
158 arrow “rotation of sample carrier transport device”
160 arrow “z-direction of sample carrier transport device”
162 stage
164 arrow “x-, y-, direction of stage”
166 arrow _{“}z-direction of head”
168 vacuum exhauster

1. A sample carrier transport device for transporting sample carriers to a plurality of workstations for sample processing, wherein the sample carrier transport device comprises a surface having a plurality of sample carrier holder portions, wherein each of the sample carrier holder portions is configured for removably holding at least one sample carrier during transport of the sample carrier to the workstations, wherein the surface is configured for performing a movement for transporting the sample carrier to the workstations, wherein the sample carrier transport device comprises at least one lifting mechanism configured for moving the surface to at least one transport position and to at least one transfer position, wherein the transport position and the transfer position refer to different heights of the surface, wherein the lifting mechanism is configured for holding the surface during transport of the sample carriers to the workstations in the transport position, wherein the sample carrier transport device is configured for handing over the sample carrier to the workstations and for receiving the sample carrier from the workstations in the transfer position.

2. The sample carrier transport device according to claim 1, wherein the handing over of the sample carrier in the transfer position comprises providing an access to the sample carrier from the workstations.

3. The sample carrier transport device according to claim 1, wherein the handing over of the sample carrier comprises placing the sample carrier on a stage of the respective workstation by moving the surface to the transfer position.

4. The sample carrier transport device according to claim 1, wherein each of the sample carrier holder portions comprises at least one opening, wherein the opening is configured for providing access to sample carrier from the workstation by one or more of: engaging, suction, exhausting a vacuum, form-fit gripping, force-fit gripping.

5. The sample carrier transport device according to claim 1, wherein the transport position is above the transfer position, wherein the lifting mechanism is configured for lifting the surface from the transfer position to the transport position for receiving the sample carrier from the workstation and transport of the sample carrier, and for lowering the surface from the transport position to the transfer position for handing over the sample carrier to the workstation, or
wherein the transport position is below the transfer position and wherein the lifting mechanism is configured for lowering the surface from the transfer position to the transport position for receiving the sample carrier from the workstation and transport of the sample carrier, and for lifting the surface from the transport position to the transfer position for handing over the sample carrier to the workstation.

6. The sample carrier transport device according to claim 1, wherein the sample carrier holder portion is configured for holding the sample carrier by using suction, exhausting a vacuum, form-fit and/or force-fit connection.

7. The sample carrier transport device according to claim 1, wherein the sample carrier holder portions are arranged on the surface with respect to distances between the respective workstations.

8. The sample carrier transport device according to claim 1, wherein the sample carrier transport device is a rotor, wherein the surface is a circular surface.

9. The sample carrier transport device according to claim 7, wherein the rotor is configured for performing a rotational movement of 360° or less than 360° around an axis of rotation of the rotor.

10. An analysis system comprising a plurality of workstations for sample processing and at least one sample carrier transport device according to claim 1, wherein the workstations and the sample carrier transport device are arranged relative to each other such that the sample carrier can be handed over of from the sample carrier transport device to the workstation and can be received from the workstation by the sample carrier transport device in the transfer position.

11. The analysis system according to claim 10, wherein each of the workstations comprises at least one workstation selected from the group consisting of: a printing workstation, a staining workstation, an analysis station, an imaging station, a wasting station, a labeling station, an intermediate store station, a reprocessing treatment station, a handing over station for further manual examination.

12. The analysis system according to claim 10, wherein the analysis system is at least one analysis system selected from the group consisting of: a hematology blood analysis system, tissue analysis system, a urine sediment analysis system.

13. A method for transporting sample carriers to a plurality of workstations of an analysis system according to claim 10, wherein the method comprises the following steps:
a) providing the sample carriers to the sample carrier holder portions of the surface of the sample carrier transport device;
b) transporting the sample carriers to the respective workstation by performing a movement of the surface, wherein each of the sample carrier holder portions removably holds a sample carrier during the transport, wherein the surface is held in a transport position during the transport by the lifting mechanism;
c) handing over the sample carrier from the sample carrier transport device to the respective workstation by using the lifting mechanism, wherein the surface is moved from the transport position to the transfer position such that the workstation can access the sample carrier.

14. The method according to claim 13, wherein the method further comprises processing the sample at the workstation.

15. The method according to claim 13, wherein the method further comprises receiving the sample carrier by the sample carrier transport device from the workstation in the transfer position and moving the surface from the transfer position to the transport position for further transport of the sample carrier.
